(19) United States
(12) Patent Application Publication
(10) Pub. No.: US 2011/0244894 A1
(43) Pub. Date: Oct. 6, 2011

(54) ELECTRONIC NETWORKING INVITATIONS

(76) Inventor: Swaminathan Mahalingam, San Jose, CA (US)

(21) Appl. No.: 12/750,640

(22) Filed: Mar. 30, 2010

(51) Int. Cl. H04W 4/00

(52) U.S. Cl. 455/466

(57) ABSTRACT

The present invention relates to a method for sending to a mobile telephone an invitation to communicate over a social networking or other invitation website using a mobile telephone number. The invention additionally provides for one-click selection to send or accept or reject the invitation using a mobile telephone number.

### BACKGROUND OF THE INVENTION

1. Field of the Invention

This invention pertains to electronic interactive communications over mobile devices, and particularly to server-client applications for sending invitations to cellular telephones for communicating via social networking and other invitation websites.

2. Description of the Prior Art

Internet communications typically require an electronic device, an Internet Service Provider to each electronic device, a host Internet Service Provider for the Internet website, and Internet service between the electronic device Internet Service Provider and the host Internet Service Provider for the Internet website. Each Internet Service Provider assigns a unique Internet Protocol (IP) address to the electronic device to facilitate communications with the electronic device.

Social networking and other invitation websites provide for discrete two-way text communications facilitated via the Internet. For secure use, the social networking website requires a username, which may be an email address, and a password linked to the account.

Some electronic devices, notably mobile telephones and personal digital assistants, may send communications over a mobile (typically cellular) network or via a Short Message Service (SMS) network. These mobile devices generally have a telephone number rather than an IP address. In this instance, the social networking website must pre-register the telephone number from an IP addressed device to link the telephone number to the account. Other limitations include a one-to-one correspondence of one telephone number to one social networking account.

### SUMMARY OF THE INVENTION

The present invention relates to a method for sending to a mobile telephone an invitation to communicate over a social networking or other invitation website using a mobile telephone number. The invention additionally provides for one-click selection to send or accept or reject the invitation using a mobile telephone number.

An exemplary embodiment comprises sending a first mobile device telephone number with a second mobile device telephone number and a social networking identifier to an invitation registration server, receiving from the invitation registration server a unique record identifier and an email address, sending to the social networking website an authentication request, sending to the social networking website the unique record identifier and the email address to initiate an invitation communication request, receiving from the invitation registration server the unique record identifier and a response that the invitation communication request was accepted or rejected; and indicating that the invitation communication request was accepted or rejected.

The exemplary embodiment may further comprise receiving from the invitation registration server the unique record identifier and the invitation communication request, displaying the invitation communication request with of an option to accept or reject the invitation communication request, and/or sending to the invitation registration server the unique record identifier with an acceptance or a rejection of the invitation communication request.

Another exemplary embodiment may comprise associating an unique record identifier with a first mobile device telephone number, a second mobile device telephone number and a social networking website, sending to a first mobile device the unique record identifier and an email address, receiving from a social networking website an invitation communication request comprising the unique record identifier and a response URL pointing to the social networking website with the email address, sending to a second mobile device the invitation communication request and the unique record identifier, receiving an acceptance or a rejection of the invitation communication request and the unique record identifier from the second mobile device, and sending to the first mobile device the unique record identifier and whether the invitation communication request was accepted or rejected.

### BRIEF DESCRIPTION OF THE DRAWINGS

FIG. 1 illustrates an exemplary system for sending an invitation communication request to a mobile device to communicate over a social networking website.

FIG. 2 illustrates a system and intercommunications for the method for sending an invitation communication request to a mobile device as an invitation to communicate over a social networking website.

FIG. 3 is a flow chart illustrating an exemplary method for sending an invitation communication request to a receiving mobile device to communicate over a social networking website as performed by an inviting mobile device.

FIG. 4 is a flow chart illustrating an exemplary method for sending an invitation communication request to a mobile device to communicate over a social networking website as performed by an invitation registration server.

FIG. 5 is a flow chart illustrating an exemplary method for sending an invitation communication request to a mobile device to communicate over a social networking website as performed by a social networking website sending the invitation communication request.

FIG. 6 is a flow chart illustrating an exemplary method for sending an invitation communication request to a mobile device to communicate over a social networking website as performed by a mobile device receiving the invitation communication request.

FIG. 7 is a block diagram of an invitation registration server in an exemplary implementation of the invention.

### DETAILED DESCRIPTION OF THE INVENTION

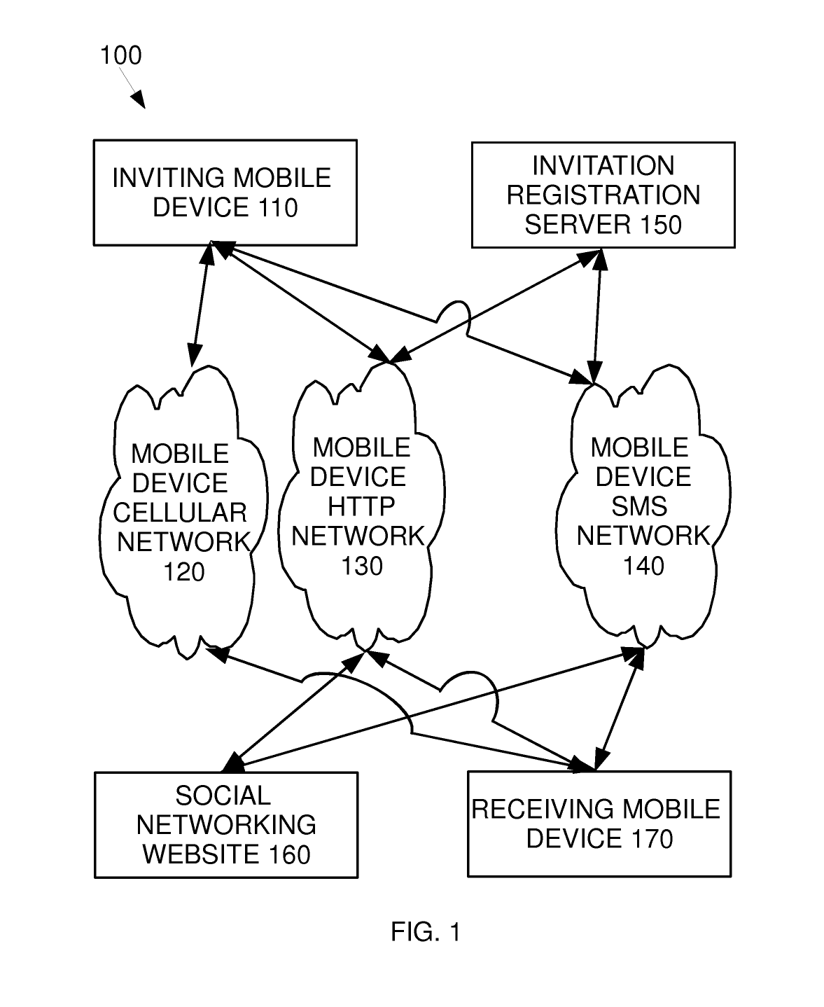

FIG. 1 illustrates an exemplary system 100 for sending an invitation communication request to a mobile device to communicate over a social networking website.

The exemplary system may comprise a first (inviting) mobile device 110, a mobile device cellular network 120, a mobile device http (Internet) network 130, a mobile device SMS network 140, an invitation registration server 150, a social networking website 160, and a second (receiving) mobile device 170.

The first (inviting) mobile device 110 may be a cellular telephone or a satellite telephone or another electronic device configured to receive and send communications via one or more mobile device wireless communication networks. The first (inviting) mobile device 110 may particularly be configured for receiving and sending data and text communications and specifically for communicating with a social networking website.

The mobile device cellular network 120 may be any wireless telecommunication network configured to receive and send communications between a mobile device and a cellular telecommunication network. The communications are typically voice communications, but may be other forms of data. The mobile device cellular network 120 may communicate using any cellular telephone protocol, for example, Global System for Mobile communications (GSM), Code Division Multiple Access (CDMA), General Packet Radio Service (GPRS), Enhanced Data Rates for GSM Evolution (EDGE) and High-Speed Circuit-Switched Data, all of which are typical.

The mobile device http (Internet) network 130 may be any wireless network configured to receive and send communications for mobile devices over the Internet. These networks typically communicate using the Hypertext Transfer Protocol (HTTP), although other devices and protocols may be involved, e.g., a modem, a router, file transfer protocol (ftp), transmission standards of the Institute of Electrical and Electronics Engineers (IEEE) Standards, e.g., 802.11 series, 802.3, Bluetooth, and so forth.

The mobile device SMS (Short Message Service) network 140 may be any wireless communication network configured to receive and send text communications to and from a mobile electronic device over a short message service network.

The Invitation Registration Server 150 may be any magnetic, electronic or optical data storage and access device configured to record and retrieve data. The Invitation Registration Server 150 is configured to store and retrieve data corresponding to personal names, usernames, mobile telephone numbers, social networking website names and identifiers, database index data, etc. The Invitation Registration Server 150 may also be configured to receive and send communications using any of the above communication protocols, particularly HTTP and SMS.

The Social Networking Website 160 may be any magnetic, electronic or optical data storage and access location for the exchange of communications posted over the Internet to a registered account. The Social Networking Website 160 may be Twitter, Linkedin, Facebook, Myspace, eVite, Friendster, etc., or any website allowing participation through invitations The Social Networking Website 160 may be configured to receive and send communications using any of the above communication protocols, particularly HTTP and SMS, although these are not inclusive nor exclusive, as the present invention operates independent of the communication protocol.

The second (receiving) mobile device 170 may be a mobile (i.e., cellular) telephone or a satellite telephone or another electronic device configured to receive and send communications via one or more mobile device wireless communication networks. The receiving mobile device 170 may particularly be configured for receiving and sending data and text communications and specifically for communicating with a social networking website.

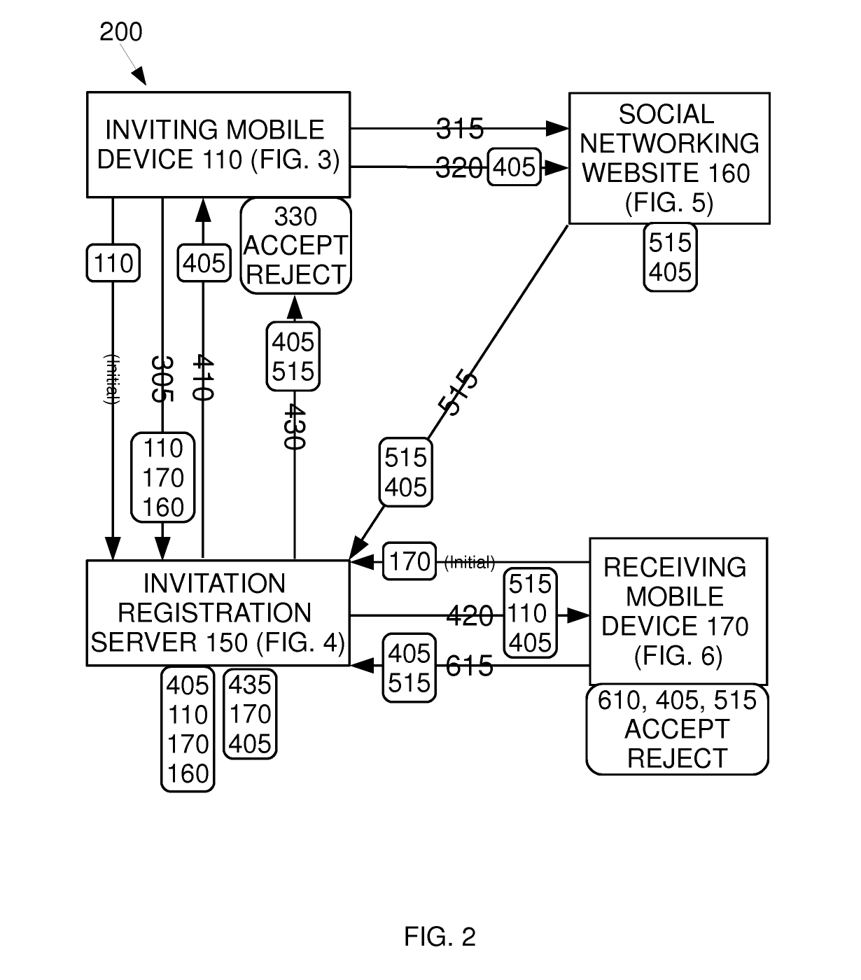

FIG. 2 illustrates the system 200 and the intercommunications for a method for sending an invitation communication request to a mobile device as an invitation to communicate over a social networking website. The system 200 comprises a first (inviting) mobile device 110, an invitation registration server 150, a social networking website 160 and a second (receiving) mobile device 170.

For clarity, FIG. 2 further shows the intercommunications for the method in its entirety for sending an invitation communication request to a mobile device to communicate over a social networking website with each step numbered according to the associated drawing for the device application described herein. Additional figures show the steps associated with the individual devices, i.e. the first (inviting) mobile device 110, the invitation registration server 150, the social networking website 160 and the second (receiving) mobile device 170.

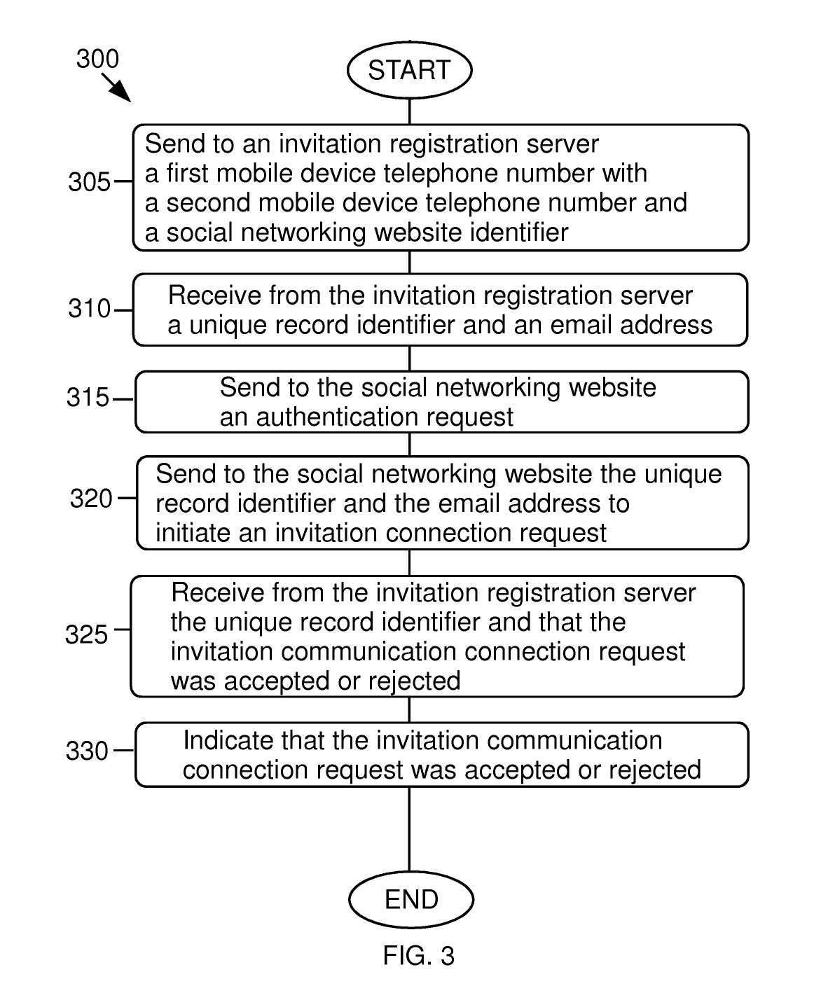

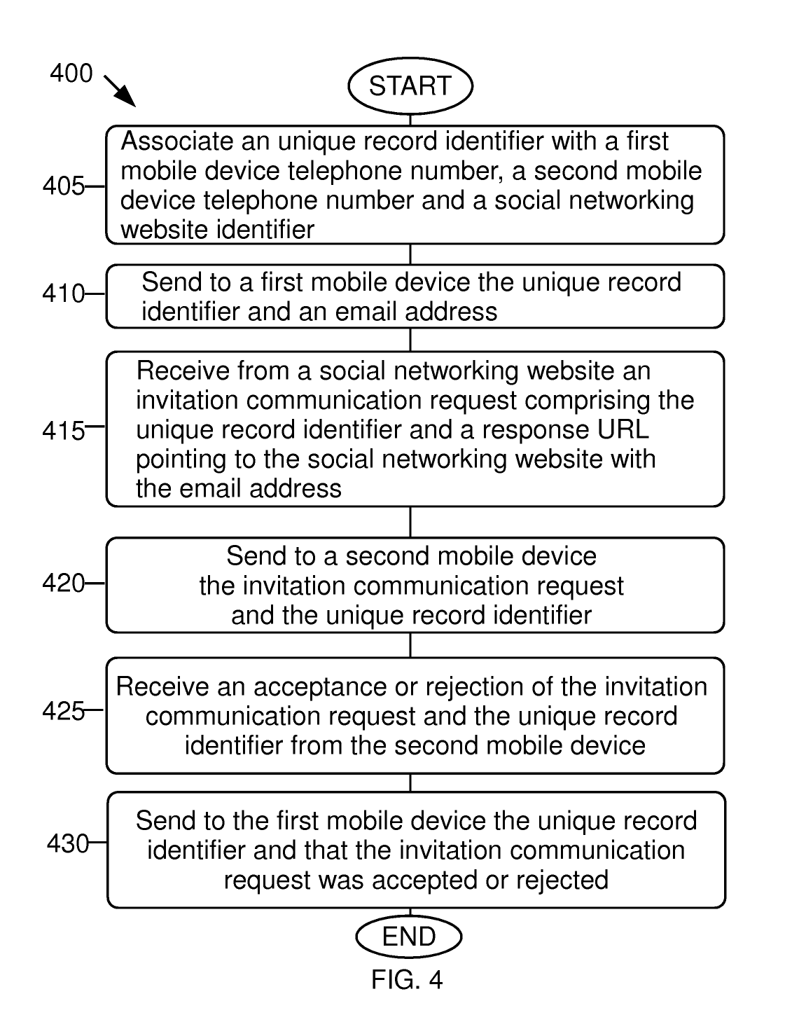

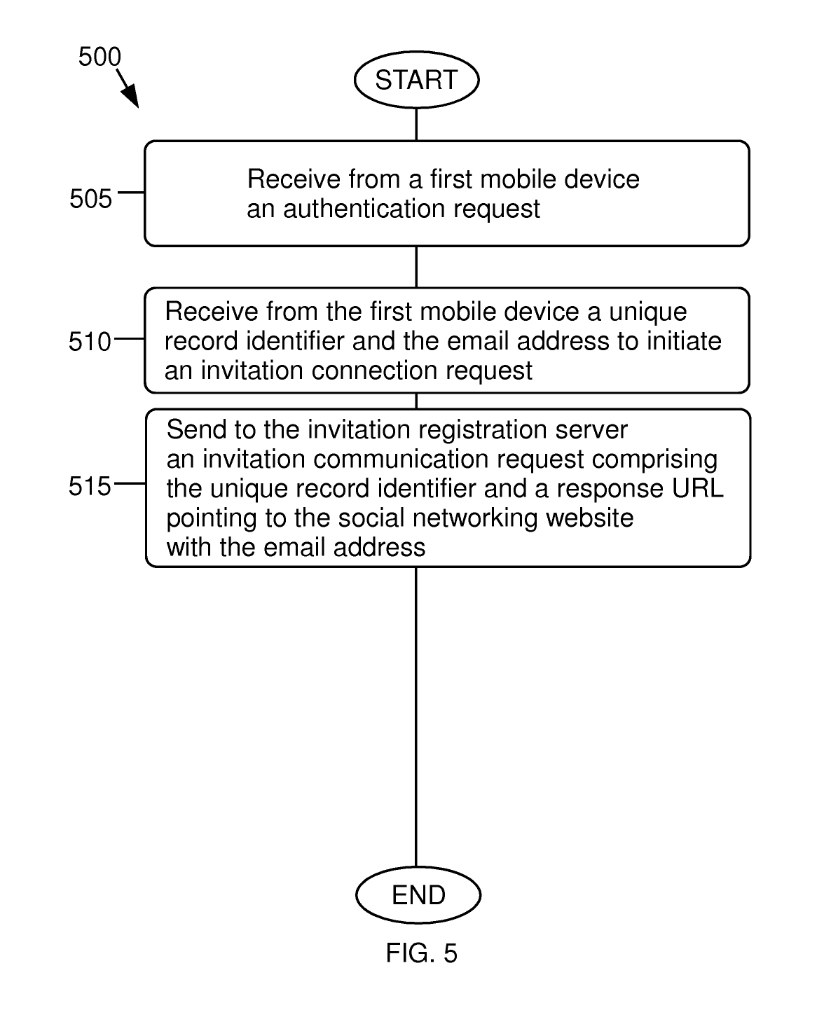

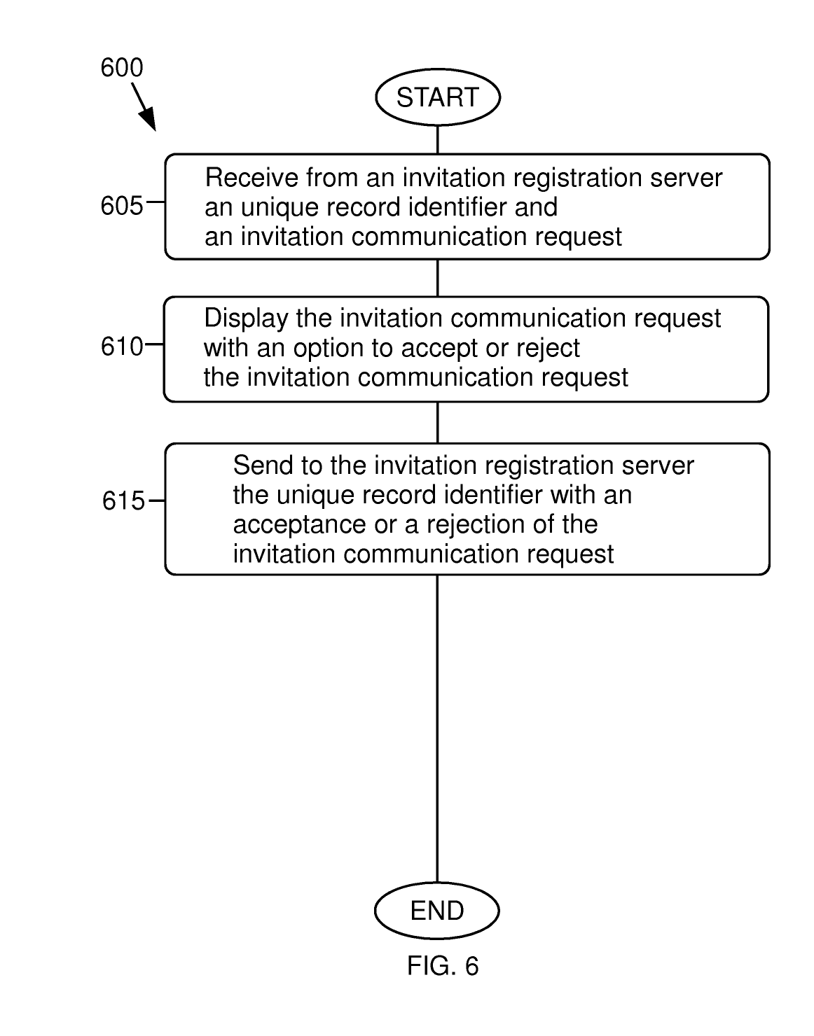

For example, FIG. 3 shows the steps 305, et. seq., associated with the first (inviting) mobile device 110. FIG. 4 shows the steps 405, et. seq., associated with the invitation registration server 150. FIG. 5 shows the steps 505, et. seq., associated with the social networking website 160. FIG. 6 shows the steps 605, et. seq., associated with the second (receiving) mobile device 170.

Initially, each mobile device user registers his or her mobile device telephone number on the invitation registration server 150 along with an identifier of a social networking website for which the user is registered. The identifier maybe the website name or a URL associated with the social networking website. A user also registers a sign-in or login email address that the user associated with the social networking website, although in some embodiments, the sign-in or login may be a username. The user also provides a default email address for contacting the user regarding an invitation to a social networking web site for which the user has not registered on the invitation registration server 150. The order in which the invitation registration server 150 receives a mobile device telephone number (i.e. 110 or 170) and social networking website identifier and email address is not material.

At step 305, the first (inviting) mobile device 110 sends to an invitation registration server 150 a first (inviting) mobile device 110 telephone number with a second (receiving) mobile device 170 telephone number and a social networking website 160 identifier.

At step 405, the invitation registration server 150 associates a unique record identifier 405 with the first (inviting) mobile device 110 telephone number, the second (receiving) mobile device 170 telephone number and the social networking website 160 identifier. The unique record identifier is a permanent record associating all invitation and communication requests pertaining to the two mobile devices 110 and 170 and the social networking website. If either user of the first (inviting) mobile device 110 or the second (receiving) mobile device 170 has already submitted the telephone number of the other mobile device along with the social networking website identifier, then the invitation registration server 150 omits creating the record as the unique record identifier already exists.

At step 410, the invitation registration server 150 sends to the first (inviting) mobile device 110 the unique record identifier 405 and the email address registered on the invitation registration server 150 for the second (receiving) mobile device 170. The email address may be the email address registered for the social networking website 160 for the user of the second (receiving) mobile device 170, or may be the default email address if the invitation registration server 150 does not have a registration of the social networking website 160 for the second (receiving) mobile device 170.

At step 310, the first (inviting) mobile device 110 receives from the invitation registration server 150 the unique record identifier 405 and the email address registered on the invitation registration server 150 for the second (receiving) mobile device 170. The unique record identifier 405 provides the first (inviting) mobile device 110 with a record associating the second (receiving) mobile device 170 with the social networking website 160, even if the user of the second (receiving) mobile device 170 has not registered with the social networking website 160.

At step 315, the first (inviting) mobile device 110 sends to the social networking website 160 an authentication request 315 to request access to the social networking website 160. The authentication request 315 typically comprises the email address or username of the user of the inviting mobile device 110 and the user's password, if required. This step is generally required, but may be optional if the social networking website does not require a user be registered and authenticated (i.e., signed-in or logged-in) to request an invitation be sent to another person.

At step 505, the social networking website 160 receives from the first (inviting) mobile device 110 the authentication request 315 to allow access to the social networking website 160.

At step 320, the first (inviting) mobile device 110 sends to the social networking website 160 the unique record identifier 405 and the email address registered on the invitation registration server 150 for the second (receiving) mobile device 170 to initiate an invitation connection request.

At step 510, the social networking website 160 receives from the first (inviting) mobile device 110 the unique record identifier 405 and the email address registered on the invitation registration server 150 for the second (receiving) mobile device 170 to initiate an invitation connection request.

At step 515, the social networking website 160 sends to the invitation registration 150 server an invitation communication request 515 comprising the unique record identifier 405 and a response URL pointing to the social networking website 160 with the email address registered on the invitation registration server 150 for the second (receiving) mobile device 170. Social networking websites not benefiting of the present invention must direct invitations to the email address of the user. The present invention allows the invitation communication request 515 to be sent to the invitation registration server 150 for direct transmission to the mobile device without using email. In this way, the present invention bypasses the usual route of sending an email to the user for a social networking invitation so the user does not require email service or an email program, both which typically require Internet service or cellular service on the mobile device.

At step 415, the invitation registration server 150 receives from the social networking website 160 the invitation communication request 515 comprising the unique record identifier 405 and a response URL pointing to the social networking website with the email address registered on the invitation registration server 150 for the second (receiving) mobile device 170. The unique record identifier 405 allows the invitation registration server 150 is able to recall the record associated to the unique record identifier 405 and the records associated to the first (inviting) mobile device 110 and the second (receiving) mobile device 170. The invitation registration server 150 also updates the record associated to the unique record identifier 405 with the response URL.

At step 420, the invitation registration server 150 sends to a second (receiving) mobile device 170 the unique record identifier 405 and the invitation communication request 515. The invitation registration server 150 also sends the first (inviting) mobile device 110 telephone number or the name registered on the invitation registration server for the first (inviting) mobile device 110.

At step 605, the second (receiving) mobile device 170 receives from the invitation registration server 150 the unique record identifier 405 and the invitation communication request 515. The second (receiving) mobile device 170 also receives the first (inviting) mobile device 110 telephone number or the name registered on the invitation registration server for the first (inviting) mobile device 110.

At step 610, the second (receiving) mobile device 170 displays the invitation communication request 515 with an option to accept or reject the invitation communication request 515. The second (receiving) mobile device 170 also displays the first (inviting) mobile device 110 telephone number or the name registered on the invitation registration server for the first (inviting) mobile device 110. The unique record identifier 405 allows either user at any time thereafter to send an invitation communication request for the same social networking website to the other user without needing to enter the identifier of the social networking website. In some embodiments, the option displayed may be ACCEPT. In some embodiments, the option displayed may be REJECT. In some embodiments, both ACCEPT and REJECT may be displayed.

At step 615, the second (receiving) mobile device 170 sends to the invitation registration server 160 the unique record identifier 405 with an acceptance or a rejection of the invitation communication request 515. The first (inviting) mobile device 110 telephone number or the name registered on the invitation registration server 150 for the first (inviting) mobile device 110 is not sent as the unique record identifier 405 uniquely associates the first (inviting) mobile device 110 and the name registered on the invitation registration server to the invitation communication request 515.

At step 425, the invitation registration server 150 receives from the second (receiving) mobile device 170 the unique record identifier 405 and an acceptance or rejection of the invitation communication request 515. The invitation registration server 150 then updates the record associated with the unique record identifier 405 as whether the invitation communication request 515 was accepted or rejected.

At step 430, the invitation registration server 150 sends to the first (inviting) mobile device 110 the unique record identifier 405 and whether the invitation communication request 515 was accepted or rejected.

At step 325, the first (inviting) mobile device 110 receives from the invitation registration server 150 the unique record identifier 405 with information of whether the invitation communication connection 515 request sent to the second (receiving) mobile device 170 was accepted or rejected.

At step 330, the first (inviting) mobile device 110 indicates whether the invitation communication connection request 515 was accepted or rejected.

FIG. 3 is a flow chart illustrating an exemplary method for sending an invitation communication request to a receiving mobile device to communicate over a social networking website as performed by an inviting mobile device.

At step 305, the first (inviting) mobile device 110 sends to an invitation registration server 150 a first (inviting) mobile device 110 telephone number with a second (receiving) mobile device 170 telephone number and a social networking website 160 identifier.

At step 310, the first (inviting) mobile device 110 receives from the invitation registration server 150 the unique record identifier 405 and the email address previously associated to the user of the second (receiving) mobile device 170. The unique record identifier 405 provides the first (inviting) mobile device 110 with a record associating the second (receiving) mobile device 170 with the social networking website 160, even if the user of the second (receiving) mobile device 170 has not registered with the social networking website 160.

At step 315, the first (inviting) mobile device 110 sends to the social networking website 160 an authentication request 315 to allow access to the social networking website 160. The authentication request 315 typically comprises the email address or username of the user of the inviting mobile device 110 and the user's password, if required. This step is generally required, but may be optional if the social networking website does not require a user be registered and authenticated (i.e., signed-in or logged-in) to request an invitation be sent to another person.

At step 320, the first (inviting) mobile device 110 sends to the social networking website 160 the unique record identifier 405 and the email address registered on the invitation registration server 150 for the second (receiving) mobile device 170 to initiate an invitation connection request.

At step 325, the first (inviting) mobile device 110 receives from the invitation registration server 150 the unique record identifier 405 with information of whether the invitation communication connection 515 request sent to the second (receiving) mobile device 170 was accepted or rejected.

At step 330, the first (inviting) mobile device 110 indicates whether the invitation communication connection request 515 was accepted or rejected.

FIG. 4 is a flow chart illustrating an exemplary method for sending an invitation communication request to a mobile device to communicate over a social networking website as performed by an invitation registration server.

At step 405, the invitation registration server 150 associates a unique record identifier 405 with the first (inviting) mobile device 110 telephone number, the second (receiving) mobile device 170 telephone number and the social networking website 160 identifier. The unique record identifier is a permanent record associating all invitation and communication requests pertaining to the two mobile devices 110 and 170 and the social networking website. If either user of the first (inviting) mobile device 110 or the second (receiving) mobile device 170 has already submitted the telephone number of the other mobile device along with the social networking website identifier, then the invitation registration server 150 omits creating the record as the unique record identifier already exists.

At step 410, the invitation registration server 150 sends to the first (inviting) mobile device 110 the unique record identifier 405 and the email address registered on the invitation registration server 150 for the second (receiving) mobile device 170. The email address may be the email address registered for the social networking website 160 for the user of the second (receiving) mobile device 170, or may be the default email address if the invitation registration server 150 does not have a registration of the social networking website 160 for the second (receiving) mobile device 170.

At step 415, the invitation registration server 150 receives from the social networking website 160 the invitation communication request 515 comprising the unique record identifier 405 and a response URL pointing to the social networking website with the email address registered on the invitation registration server 150 for the second (receiving) mobile device 170. The unique record identifier 405 allows the invitation registration server 150 is able to recall the record associated to the unique record identifier 405 and the records associated to the first (inviting) mobile device 110 and the second (receiving) mobile device 170. The invitation registration server 150 also updates the record associated to the unique record identifier 405 with the response URL.

At step 420, the invitation registration server 150 sends to a second (receiving) mobile device 170 the unique record identifier 405 and the invitation communication request 515. The invitation registration server 150 also sends the first (inviting) mobile device 110 telephone number or the name registered on the invitation registration server for the first (inviting) mobile device 110.

At step 425, the invitation registration server 150 receives from the second (receiving) mobile device 170 the unique record identifier 405 and an acceptance or rejection of the invitation communication request 515. The invitation registration server 150 then updates the record associated with the unique record identifier 405 as whether the invitation communication request 515 was accepted or rejected.

At step 430, the invitation registration server 150 sends to the first (inviting) mobile device 110 the unique record identifier 405 and whether the invitation communication request 515 was accepted or rejected.

FIG. 5 is a flow chart illustrating an exemplary method for sending an invitation communication request to a mobile device to communicate over a social networking website as performed by a social networking website sending the invitation communication request.

At step 505, the social networking website 160 receives from the first (inviting) mobile device 110 the authentication request 315 to allow access to the social networking website 160.

At step 510, the social networking website 160 receives from the first (inviting) mobile device 110 the unique record identifier 405 and the email address registered on the invitation registration server 150 for the second (receiving) mobile device 170 to initiate an invitation connection request.

At step 515, the social networking website 160 sends to the invitation registration 150 server an invitation communication request 515 comprising the unique record identifier 405 and a response URL pointing to the social networking website 160 with the email address registered on the invitation registration server 150 for the second (receiving) mobile device 170. Social networking websites not benefiting of the present invention must direct invitations to the email address of the user. The present invention allows the invitation communication request 515 to be sent to the invitation registration server 150 for direct transmission to the mobile device without using email. In this way, the present invention bypasses the usual route of sending an email to the user for a social networking invitation so the user does not require email service or an email program, both which typically require Internet service or cellular service on the mobile device.

FIG. 6 is a flow chart illustrating an exemplary method for sending an invitation communication request to a mobile device to communicate over a social networking website as performed by a mobile device receiving the invitation communication request.

At step 605, the second (receiving) mobile device 170 receives from the invitation registration server 150 the unique record identifier 405 and the invitation communication request 515. The second (receiving) mobile device 170 also receives the first (inviting) mobile device 110 telephone number or the name registered on the invitation registration server for the first (inviting) mobile device 110.

At step 610, the second (receiving) mobile device 170 displays the invitation communication request 515 with an option to accept or reject the invitation communication request 515. The second (receiving) mobile device 170 also displays the first (inviting) mobile device 110 telephone number or the name registered on the invitation registration server for the first (inviting) mobile device 110. The unique record identifier 405 allows either user at any time thereafter to send an invitation communication request for the same social networking website to the other user without needing to enter the identifier of the social networking website. In some embodiments, the option displayed may be ACCEPT. In some embodiments, the option displayed may be REJECT. In some embodiments, both ACCEPT and REJECT may be displayed.

At step 615, the second (receiving) mobile device 170 sends to the invitation registration server 160 the unique record identifier 405 with an acceptance or a rejection of the invitation communication request 515. The first (inviting) mobile device 110 telephone number or the name registered on the invitation registration server 150 for the first (inviting) mobile device 110 is not sent as the unique record identifier 405 uniquely associates the first (inviting) mobile device 110 and the name registered on the invitation registration server to the invitation communication request 515.

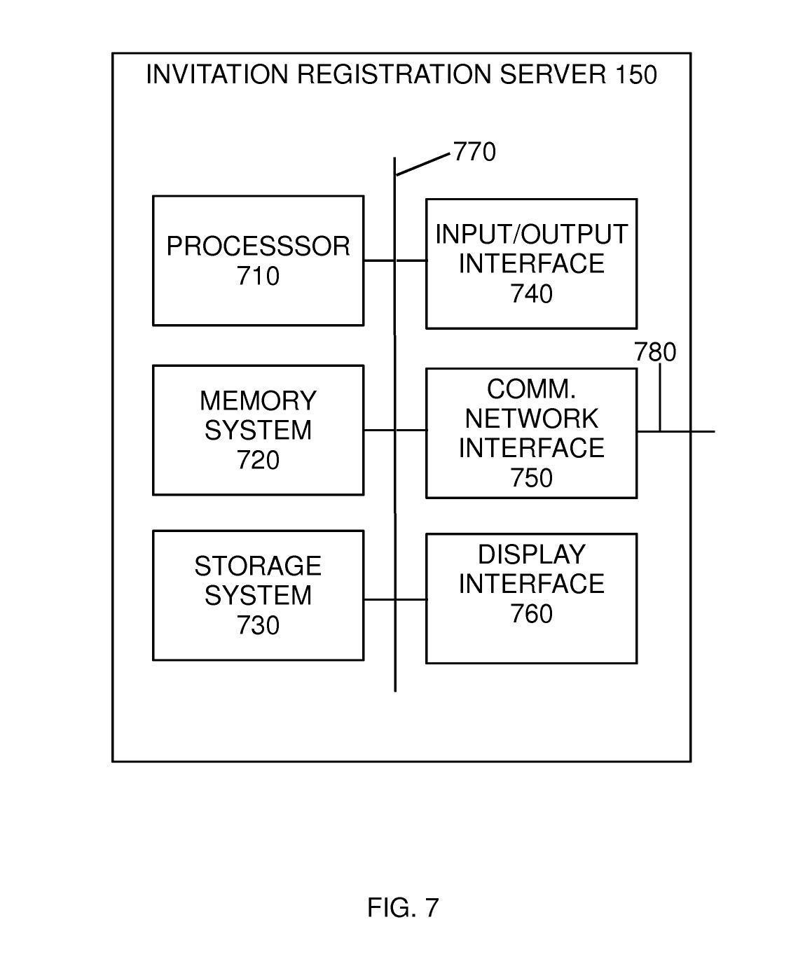

FIG. 7 is a block diagram of the invitation registration server 150 in one exemplary implementation of the invention. The invitation registration server 150 comprises a processor 710, a memory system 720, a storage system 730, an input/output (“I/O”) interface 740, a communication network interface 750, and a display interface 760 which may be coupled to a system bus 770. The processor 710 is configured to execute executable instructions. In some embodiments, the processor 710 comprises circuitry or any processor capable of processing the executable instructions.

The memory system 720 may be any memory configured to store data. Some examples of the memory 720 are storage devices, such as RAM or ROM. The storage system 730 may be any storage configured to retrieve and store data. Some examples of the storage system 730 are hard drives, optical drives, flash drives, and magnetic tape. In some embodiments, the invitation registration server 150 may include the memory system 720 in the form of RAM and the storage system 730 in the form of flash data.

The I/O interface 740 may be any device that can receive input for controlling and accessing the invitation registration server 150. The I/O interface 740 may couple to a keyboard, touch-screen, mouse, keypad, printer, scanner, or any other input or output device.

The communication network interface 750 may be coupled to the mobile device cellular network 120, the mobile device http network 130, the mobile device SMS network 140 or to any of the communication systems stated herein via the link 780. FIG. 7 shows a single link 780 for simplicity. However, the invitation registration server 150 may include more than one of the link 780. Moreover, the communication network interface 750 may support communication over many kinds of connections, including, but not limited to, a USB connection, a firewire connection, an Ethernet connection, a serial connection, a parallel connection, or an ATA connection. The communication network interface 750 may also support wireless communication (e.g., 802.11 a/b/g/n. or wireless USB).

The display interface 760 is any device that may control a display device. A display device can be a monitor, screen, LCD, flatscreen, or any device configured to display information. The display device may be provided to control and access the invitation registration server 150.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

I claim:

1. A method for sending to a mobile telephone an invitation to communicate over a social networking website using a mobile telephone number comprising:
sending to an invitation registration server a first mobile device telephone number with a second mobile device telephone number and a social networking website identifier;
receiving from the invitation registration server a unique record identifier and an email address;
sending to the social networking website an authentication request;
sending to the social networking website the unique record identifier and the email address to initiate an invitation communication request;
receiving from the invitation registration server the unique record identifier and a response that the invitation communication request was accepted or rejected; and
indicating that the invitation communication request was accepted or rejected.

2. The method for sending to a mobile telephone an invitation to communicate over a social networking website using a mobile telephone number of claim 1 further comprising receiving from the invitation registration server the unique record identifier and the invitation communication request.

3. The method for sending to a mobile telephone an invitation to communicate over a social networking website using a mobile telephone number of claim 1 further comprising displaying the invitation communication request with an option to accept or reject the invitation communication request.

4. The method for sending to a mobile telephone an invitation to communicate over a social networking website using a mobile telephone number of claim 1 further comprising sending to the invitation registration server the unique record identifier with an acceptance or a rejection of the invitation communication request.

5. The method for sending to a mobile telephone an invitation to communicate over a social networking website using a mobile telephone number of claim 1 wherein the social networking website identifier is a domain name.

6. The method for sending to a mobile telephone an invitation to communicate over a social networking website using a mobile telephone number of claim 1 wherein the social networking website identifier is a Uniform Resource Locator.

7. The method for sending to a mobile telephone an invitation to communicate over a social networking website using a mobile telephone number of claim 3 wherein the option displayed is ACCEPT.

8. The method for sending to a mobile telephone an invitation to communicate over a social networking website using a mobile telephone number of claim 3 wherein the option displayed is REJECT.

9. The method for sending to a mobile telephone an invitation to communicate over a social networking website using a mobile telephone number of claim 3 wherein both options ACCEPT or AREJECT are displayed.

10. A method for sending to a mobile telephone an invitation to communicate over a social networking website using a mobile telephone number comprising:
associating an unique record identifier with a first mobile device telephone number, a second mobile device telephone number and a social networking website identifier;
sending to a first mobile device the unique record identifier and an email address;
receiving from a social networking website an invitation communication request comprising the unique record identifier and a response URL pointing to the social networking website with the email address;
sending to a second mobile device the invitation communication request and the unique record identifier;
receiving an acceptance or a rejection of the invitation communication request and the unique record identifier from the second mobile device; and
sending to the first mobile device the unique record identifier and that the invitation communication request was accepted or rejected.

11. The method for sending to a mobile telephone an invitation to communicate over a social networking website using a mobile telephone number of claim 10 further comprising associating the second mobile device telephone number with an email address.

12. The method for sending to a mobile telephone an invitation to communicate over a social networking website using a mobile telephone number of claim 10 wherein the social networking website identifier is a domain name.

13. The method for sending to a mobile telephone an invitation to communicate over a social networking website using a mobile telephone number of claim 10 wherein the social networking website identifier is a Uniform Resource Locator.

14. A method for sending to a mobile telephone an invitation to communicate over a social networking website using a mobile telephone number comprising:
receiving from a first mobile device an authentication request;
receive from the first mobile device the unique record identifier and an email address to initiate an invitation connection request; and
sending to an invitation registration server an invitation communication request comprising the unique record identifier and a response URL pointing to the social networking website with the email address.

15. A computer-readable storage medium having a computer-executable program for sending to a mobile telephone an invitation to communicate over a social networking website using a mobile telephone number comprising the steps of: associating an unique record identifier with a first mobile device telephone number, a second mobile device telephone number and a social networking website identifier; sending to a first mobile device the unique record identifier and an email address; receiving from a social networking website an invitation communication request comprising the unique record identifier and a response URL pointing to the social networking website with the email address; sending to a second mobile device the invitation communication request and the unique record identifier; receiving an acceptance or a rejection of the invitation communication request and the unique record identifier from the second mobile device; and sending to the first mobile device the unique record identifier and that the invitation communication request was accepted or rejected.
